(19) United States
(12) Patent Application Publication
(10) Pub. No.: US 2025/0116358 A1
(43) Pub. Date: Apr. 10, 2025

(54) Coupling

(71) Applicant: Victaulic Company, Easton, PA (US)

(72) Inventors: Matthew A. Bowman, Palmer, PA (US); Christopher A. Richards, Saylorsburg, PA (US)

(21) Appl. No.: 18/887,712

(22) Filed: Sep. 17, 2024

Related U.S. Application Data
(60) Provisional application No. 63/589,060, filed on Oct. 10, 2023.

(51) Int. Cl. F16L 19/00

(52) U.S. Cl. CPC F16L 19/00; F16L 2201/10

(57) ABSTRACT

A pipe coupling has two segments with lugs adapted to receive adjustable fasteners to draw the segments together to join pipe elements. Each lug has an inner surface and a stop surface in spaced relationship. The stop surfaces on corresponding lugs contact each other when the adjustable fasteners are tightened.

### CROSS REFERENCE TO RELATED APPLICATIONS

This application is based upon and claims priority to U.S. Provisional Application No. 63/589,060, filed Oct. 10, 2023, which application is hereby incorporated by reference.

### FIELD OF THE INVENTION

This invention relates to mechanical couplings for joining pipe elements.

### BACKGROUND

It is advantageous to install a coupling that has segments that can be connected to one another at one end and then the other. Segments that are designed to be completely fastened to one another at one end and then the other may take less time to install than segments that are installed by tightening the fasteners progressively. Segments having bolt pads that have outer portions which contact each other upon tightening reduce the likelihood of overtightening and provide a visual indicator of complete and proper assembly. Pipe element tolerance ranges and tolerance ranges on the interfacing surface of the coupling may cause a gap between segments. These gaps may leave the gasket exposed and/or allow the gasket to bulge. Further, the exposed gasket may erroneously indicate to the installer that the coupling is not completely or properly installed. There is clearly an opportunity to improve segmented mechanical couplings so they are easier to assemble, provide consistent and unambiguous visual indication of proper installation, and protect and properly compress the gasket.

### SUMMARY

An example coupling for joining pipe elements in end to end relation according to the invention comprises first and second segments attached to one another end to end surrounding a central space for receiving the pipe elements. Each segment comprises a first lug extending from a first end thereof and a second lug extending from a second end thereof. A first adjustable fastener extends between the first lugs along a first longitudinal axis and a second adjustable fastener extends between the second lugs along a second longitudinal axis. Each segment further comprises a first inner surface positioned between the central space and the first lug. The first inner surface comprising a first tooth and a first recess. Each segment further comprises a first stop surface positioned on the first lug. The first adjustable fastener being positioned between the first inner surface and the first stop surface. Each segment further comprises a second inner surface positioned between the central space and the second lug. The second inner surface comprising a second tooth and a second recess. Each segment further comprises a second stop surface positioned on the second lug. The second adjustable fastener being positioned between the second inner surface and the second stop surface. The first and second segments are movable toward one another to a tightened condition. The first and second adjustable fasteners are configured to draw the first and second segments toward one another to the tightened condition. In the tightened condition, the first stop surfaces at the first ends of the segments engage and the second stop surfaces at the second ends of the segments engage. The first tooth of the first segment is at least partially received within the first recess of the second segment and the first tooth of the second segment is at least partially received within the first recess of the first segment.

In an example embodiment, in the tightened condition, the second tooth of the first segment mates with the second recess of the second segment and the second recess of the first segment mates with the second tooth of the second segment.

In an example embodiment, in the tightened condition, a first gap is present between the first stop surfaces.

In a further example embodiment, in the tightened condition, a second gap is present between the second inner surfaces.

In an example embodiment, the first lugs define a first opening surrounding a first axis oriented perpendicularly to the first longitudinal axis of the first adjustable fastener and positioned between the first inner surfaces and the first stop surfaces.

In a further example embodiment, the first opening extends through the first lugs.

In an example embodiment, the second lugs define a second opening surrounding a second axis oriented perpendicularly to the second longitudinal axis of the second adjustable fastener and positioned between the second inner surfaces and the second stop surfaces.

In a further example embodiment, the second opening extends through the second lugs.

In an example embodiment, the first tooth of the first segment aligns with the first recess of the second segment, and the first recess of the first segment aligns with the first tooth of the second segment.

In a further example embodiment, the first tooth surface is oriented at a first angle to a first plane, the first plane containing a transverse axis and the first and second axes, the transverse axis oriented perpendicularly to the first and second longitudinal axes and the first and second axes, and wherein the first recess surface is oriented at a second angle to the first plane.

In a further example embodiment, the second angle has an opposite slope from the first angle.

In a further example embodiment, a magnitude of the second angle is substantially the same as a magnitude of the first angle.

In a further example embodiment, the slope of the first angle ranges from 10° to 70°, and the slope of the second angle ranges from 10° to 70°.

In an example embodiment, the second tooth of the first segment aligns with the second recess of the second segment, and the second recess of the first segment aligns with the second tooth of the second segment.

In a further example embodiment, the second tooth surface is oriented at a third angle to the first plane, and the second recess surface is oriented at a fourth angle to the first plane.

In a further example embodiment, the third angle has an equal and opposite slope from the first angle, and the fourth angle has an equal and opposite slope from the second angle.

In an example embodiment, the coupling further comprises a first pair of shoulders positioned adjacent the first tooth and the first recess. Each shoulder of the first pair of shoulders has a first shoulder surface. The coupling further comprises a second pair of shoulders positioned adjacent the second tooth and the second recess. Each shoulder of the second pair of shoulders has a second shoulder surface.

In a further example embodiment, the first shoulder surface is oriented substantially parallel to the first plane, and the second shoulder surface is oriented substantially parallel to the first plane.

In an example embodiment, the first stop surface comprises a first portion oriented at a fifth angle to a second plane. The second plane contains the first and second longitudinal axes and the transverse axis. The second stop surface comprises a first portion oriented at a sixth angle to the second plane.

In a further example embodiment, the sixth angle has an equal and opposite slope from the fifth angle.

In a further example embodiment, the first stop surface further comprises at least one second portion oriented at a seventh angle to the second plane, and the second stop surface comprises at least one second portion oriented at an eighth angle to the second plane.

In a further example embodiment, the eighth angle has an equal and opposite slope from the seventh angle.

In a further example embodiment, the seventh angle has an opposite slope from the fifth angle, and the eighth angle has an opposite slope from the sixth angle.

In an example embodiment, each one of the first and second adjustable fasteners comprises a nut and bolt.

In an example embodiment, each of the segments comprises first and second arcuate projections positioned on opposite sides of the segments. Each of the first and second arcuate projections faces the central space. Each of the first and second arcuate projections is engageable within circumferential grooves in the pipe elements when the segments are drawn toward one another by the first and second adjustable fasteners.

In an example embodiment, a seal is positioned within the central space. The seal supports the segments in spaced apart relation sufficient to permit insertion of the pipe elements into the central space without disassembling the coupling.

An example method of using the coupling according to the invention comprises adjusting the first adjustable fastener to draw the first and second segments toward one another. The method comprises engaging the first stop surfaces at the first end of the segments. The method comprises adjusting the second adjustable fastener to draw the first and second segments toward one another. The method comprises engaging the second stop surfaces of the second end of the segments.

In an example embodiment, the first stop surfaces at the first end of the segments engage before adjusting the second adjustable fastener.

In a further example embodiment, the coupling is in the tightened condition after the second stop surfaces engage.

In a further example embodiment, the first segment and the second segment are in an alignment with respect to an axis parallel to and centered between the first longitudinal axis and the second longitudinal axis and remain in the alignment in the tightened condition.

An example coupling for joining pipe elements in end to end relation according to the invention comprises first and second segments attached to one another end to end surrounding a central space for receiving the pipe elements. Each segment comprises a first end and a second end. Each segment comprises a first lug extending from a first end thereof. A first adjustable fastener extends between the first lugs along a first longitudinal axis. A hinge assembly attaches the second ends of the first and second segments. Each segment further comprises a first inner surface positioned between the central space and the first lug. The first inner surface comprises a first tooth and a first recess. Each segment comprises a first stop surface positioned on the first lug. The first adjustable fastener is positioned between the first inner surface and the first stop surface. The first and second segments are movable toward one another to a tightened condition. The first adjustable fastener is configured to draw the first and second segments toward one another to the tightened condition. In the tightened condition, the first stop surfaces at the first ends of the segments engage, and the first tooth of the first segment is at least partially received within the first recess of the second segment and the first tooth of the second segment is at least partially received within the first recess of the first segment.

In an example embodiment, in the tightened condition, a first gap is present between the first stop surfaces.

In an example embodiment, the first lugs define a first opening surrounding a first axis oriented perpendicularly to the first longitudinal axis of the first adjustable fastener and positioned between the first inner surfaces and the first stop surfaces.

In a further example embodiment, the first opening extends through the first lugs.

In an example embodiment, the first tooth of the first segment aligns with the first recess of the second segment, and the first recess of the first segment aligns with the first tooth of the second segment.

In an example embodiment, the first tooth surface is oriented at a first angle to a first plane. The first plane contains a transverse axis and the first and second axes. The transverse axis oriented perpendicularly to the first and second longitudinal axes and the first and second axes. The first recess surface is oriented at a second angle to the first plane.

In a further example embodiment, the second angle has an opposite slope from the first angle.

In a further example embodiment, a magnitude of the second angle is substantially the same as a magnitude of the first angle.

In a further example embodiment, the slope of the first angle ranges from 10° to 70°, and the slope of the second angle ranges from 10° to 70°.

In an example embodiment, the coupling further comprises a first pair of shoulders positioned adjacent the first tooth and the first recess, each shoulder of the first pair of shoulders having a first shoulder surface.

In a further example embodiment, the first shoulder surface is oriented substantially parallel to the first plane.

In an example embodiment, the first stop surface comprises a first portion oriented at a fifth angle to a second plane. The second plane contains the first and second longitudinal axes and the transverse axis.

In a further example embodiment, the first stop surface further comprises at least one second portion oriented at a seventh angle to the second plane.

In a further example embodiment, the seventh angle has an opposite slope from the fifth angle.

In an example embodiment, the first adjustable fastener comprises a nut and bolt.

In an example embodiment, each of the segments comprises first and second arcuate projections positioned on opposite sides of the segments. Each of the first and second arcuate projections faces the central space. Each of the first and second arcuate projections is engageable within circumferential grooves in the pipe elements when the segments are drawn toward one another by the first adjustable fasteners.

In an example embodiment, the coupling further comprises a seal positioned within the central space. The seal supports the segments in spaced apart relation sufficient to permit insertion of the pipe elements into the central space without disassembling the coupling.

### BRIEF DESCRIPTION OF THE DRAWINGS

FIG. 1 is an isometric view of an example mechanical coupling according to the invention;

FIG. 2 is an isometric view of an example segment according to the invention;

FIG. 3 is a transparent side view of the segments of the example mechanical coupling shown in FIG. 1;

FIG. 4 is an end view of the segments of the example mechanical coupling shown in FIG. 1;

FIG. 4A is an end view of the segments shown in FIG. 4 in a tightened condition;

FIG. 4B is an end view of example segments of an example mechanical coupling;

FIG. 4C is an end view of the example segments of the example mechanical coupling shown in FIG. 4B in a tightened condition;

FIG. 4D is an end view of example segments of an example mechanical coupling;

FIG. 4E is an end view of the example segments of the example mechanical coupling shown in FIG. 4D in a tightened condition;

FIG. 4F is an end view of example segments of an example mechanical coupling;

FIG. 4G is an end view of the example segments of the example mechanical coupling shown in FIG. 4F in a tightened condition;

FIG. 5 is an isometric view of the example mechanical coupling shown in FIG. 1 with an example seal shown in a factory assembled state;

FIG. 6 is a side view of the example mechanical coupling and seal shown in FIG. 11;

FIG. 7 is a side perspective view of the segments of the example mechanical coupling shown in FIG. 1 in a tightened condition under a first tolerance;

FIG. 8 is an enlarged view of section 8 in FIG. 7;

FIG. 9 is an enlarged view of section 9 in FIG. 7;

FIG. 10 is a side perspective view of the segments of the example mechanical coupling shown in FIG. 1 in a tightened condition under a second tolerance;

FIG. 11 is an enlarged view of section 11 in FIG. 10;

FIG. 12 is an enlarged view of section 12 in FIG. 10;

FIG. 13 is a front view of an example seal;

FIG. 14 is a side view of an example mechanical coupling having three segments according to the invention; and

FIG. 15 is a side view of an example hinged mechanical coupling according to the invention.

### DETAILED DESCRIPTION

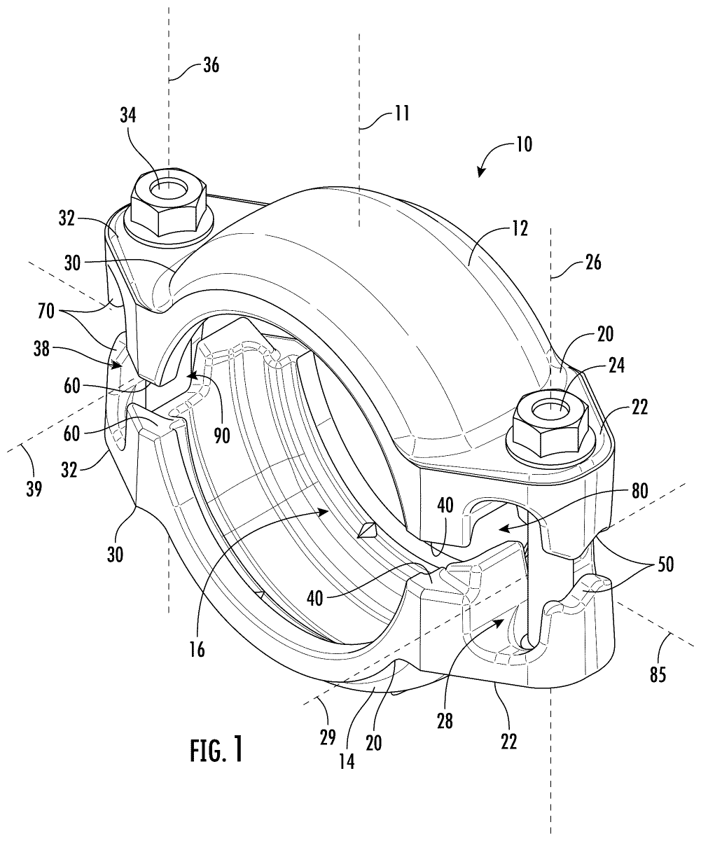

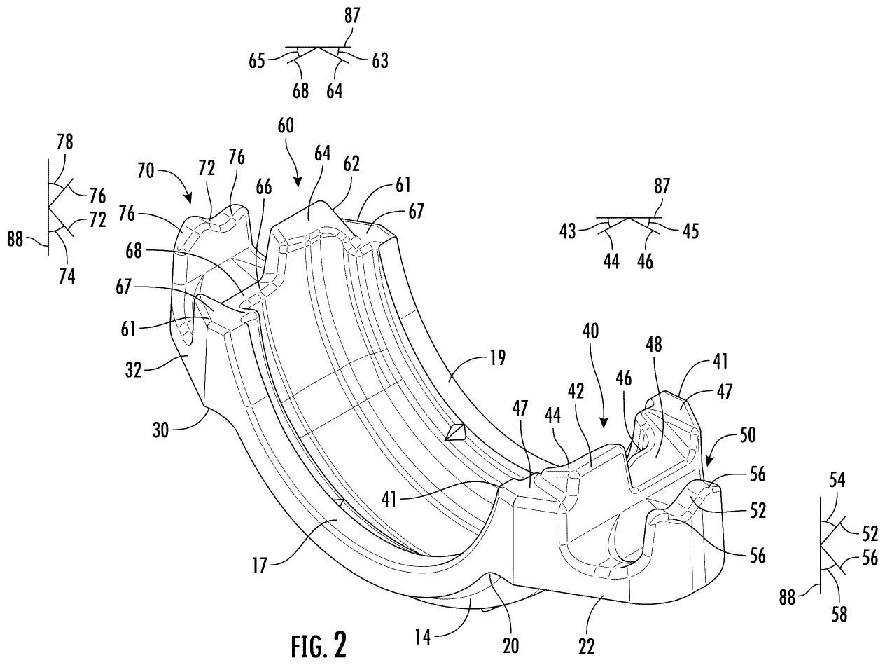

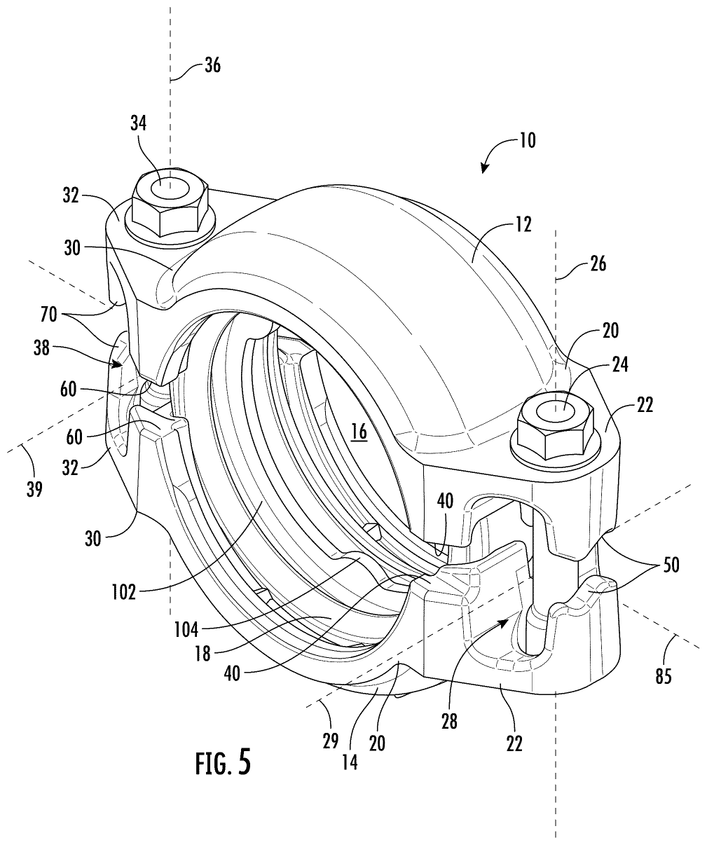

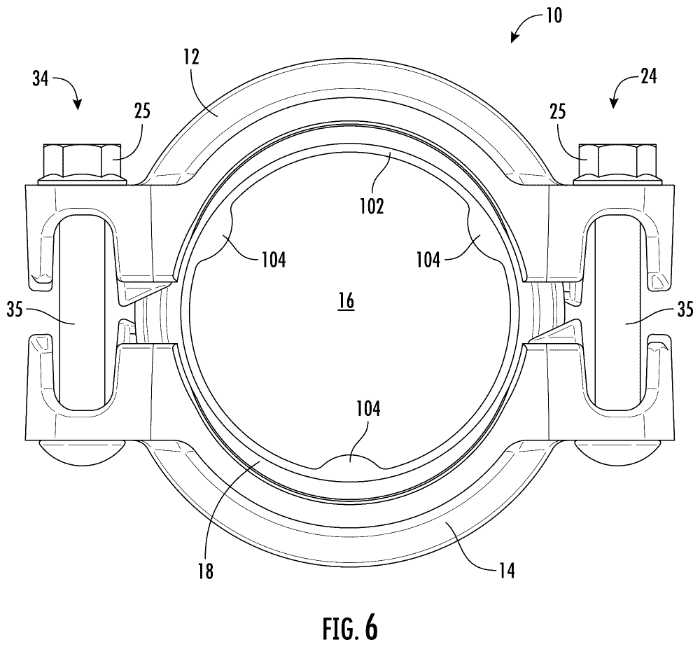

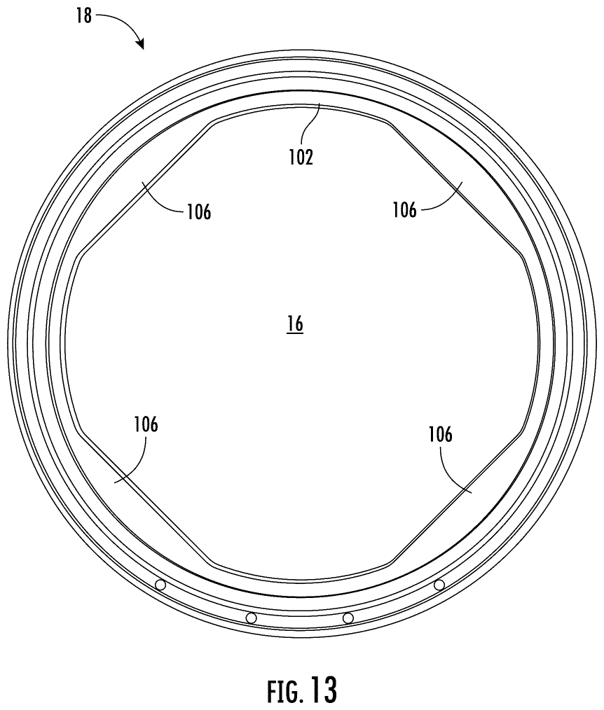

FIG. 1 shows an example coupling 10 according to the invention for joining pipe elements (not shown) in end to end relation. The coupling 10 comprises first and second segments 12, 14. The first segment 12 and second segment 14 are attached to one another end to end to surround and define a central space 16 for receiving the pipe elements. As shown in FIG. 2, the coupling 10 may include first and second arcuate projections 17, 19, also known as “keys,” positioned on opposite sides of the segments 12, 14. The arcuate projections 17, 19 are configured to mate with circumferential grooves at the ends of the pipe elements joined by the coupling 10. The arcuate projections 17, 19 face the central space 16 and are engageable within the circumferential grooves in the pipe elements when the segments are drawn together to join the pipe elements. As shown in FIGS. 5 and 6, the coupling 10 may further comprise a seal 18 positioned within the central space 16. The seal 18 may be a ring gasket made of an elastomer such as EPDM. The seal 18 may support the segments 12, 14 in spaced apart relation sufficient to permit insertion of the pipe elements into the central space 16 without disassembling the coupling 10. As shown in FIGS. 5 and 6, the seal 18 may comprise a center leg 102 including a plurality of projections 104. The projections 104 may be rounded. Alternatively, as shown in FIG. 13, the center leg 102 may include portions 106 comprising edges having a radial spacing from the center of the central space 16 that is less than the radial spacing of the remaining edges of the center leg 102. Optionally, the portions 106 may have linear or substantially linear edges. The pipe elements may be inserted into the central space 16 to the extent that they contact the center leg 102 of the seal 18, which acts as a pipe stop. When the ends of the pipe elements contact the center leg 102, each arcuate projection 17, 19 may align with a respective circumferential groove in each pipe element. Beneficially, the seal 18 with center leg 102 having projections 104 or portions 106 may be used to assemble couplings 10 and pipe elements having straight or beveled ends. Couplings according to the invention may also be used with plain end pipe, shouldered pipe or other formed pipe ends known in the art.

As further shown in FIG. 1, each segment 12, 14 comprises a first lug 22 extending from a first end 20 thereof. A first adjustable fastener 24 extends between the first lugs 22 along a first longitudinal axis 26. The first lugs 22 may define a first opening 28 surrounding a first axis 29 oriented perpendicularly to the first longitudinal axis 26 of the first adjustable fastener 24. The first opening 28 may extend through the first lugs 22. The bending stiffness of the first lugs 22 may be tuned to a desired value by properly sizing the first opening 28. A second lug 32 extends from a second end 30 of each segment 12, 14. A second adjustable fastener 34 extends between the second lugs 32 along a second longitudinal axis 36. The second lugs 32 may define a second opening 38 surrounding a second axis 39 oriented perpendicularly to the second longitudinal axis 36 of the second adjustable fastener 34. The second opening 38 may extend through the second lugs 32. The bending stiffness of the second lugs 32 may be tuned to a desired value by properly sizing the second opening 31. Preferably, the first lugs 22 and the second lugs 32 are tuned to the same bending stiffness. As shown in FIG. 6, each fastener 24, 34 may comprise a nut 25 and bolt 35. The adjustable fasteners 24, 34 may be tightened to draw the segments 12, 14 together.

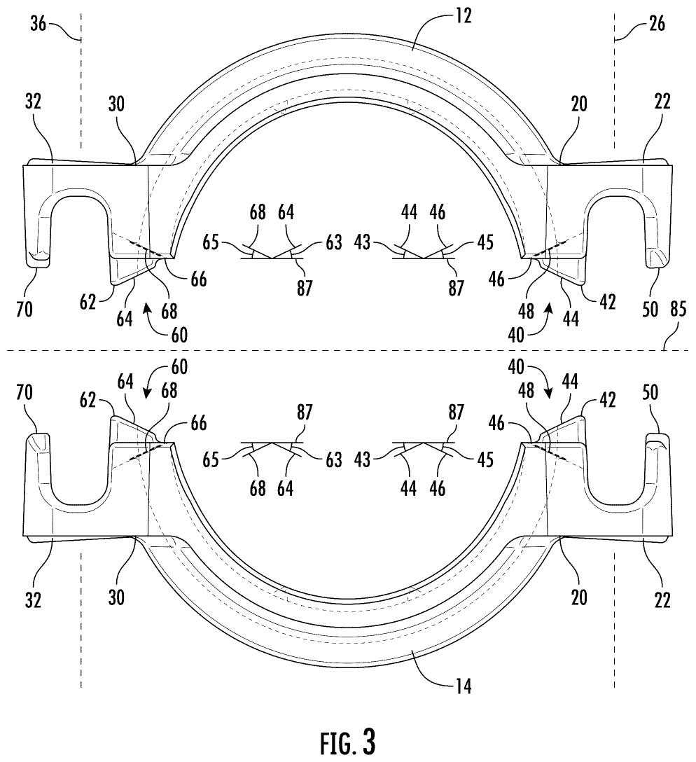

As shown in FIGS. 1 and 3, each segment 12, 14 further comprises a first inner surface 40 positioned between the central space 16 and the first lug 22. As shown in FIGS. 2 and 3, the first inner surface 40 may comprise a first tooth 42. The first tooth 42 has a first tooth surface 44. The first inner surface 40 may comprise a first recess 46. The first recess 46 has a first recess surface 48. The first tooth 42 of the first segment 12 aligns with and is configured to mate with the first recess 46 of the second segment 14. The first recess 46 of the first segment 12 aligns with and is configured to mate with the first tooth 42 of the second segment 14. The first tooth surface 44 may be oriented at a first angle 43 to a first plane 87. The first plane 87 contains a transverse axis 85 and the first and second axes 29, 39. The transverse axis 85 may be oriented perpendicularly to the first and second longitudinal axes 26, 36 and the first and second axes 29, 39. The first recess surface 48 may be oriented at a second angle 45 to the first plane 87. The second angle 45 may have an opposite slope (opposite in sign) from the first angle 43. The magnitude of the second angle 45 may be the same or substantially the same (for example, within 5° to 10°) as the magnitude of the first angle 43. The slope of the first angle 43 may range from 10° to 70°. The slope of the first angle 43 may preferably range from 20° to 25°. The slope of the second angle 45 may range from 10° to 70°. The slope of the second angle 45 may range from 20° to 25°.

As shown in FIGS. 1 and 3, each segment 12, 14 comprises a second inner surface 60 positioned between the central space 16 and the second lug 32. As shown in FIGS. 2 and 3, the second inner surface 60 may comprise a second tooth 62. The second tooth 62 has a second tooth surface 64. The second inner surface 60 may comprise a second recess 66. The second recess 66 has a second recess surface 68. The second tooth 62 of the first segment 12 aligns with and is configured to mate with the second recess 66 of the second segment 14. The second recess 66 of the first segment 12 aligns with and is configured to mate with the second tooth 62 of the second segment 14. The second tooth surface 64 may be oriented at a third angle 63 to the first plane 87. The second recess surface 68 may be oriented at a fourth angle 65 to the first plane 87. The third angle 63 has an opposite slope (opposite in sign) from the first angle 43. It may be advantageous for the third angle 63 to have a slope that is equal (in magnitude) or substantially equal (for example, within 5° to 10°) to the slope of the first angle 43. The fourth angle 65 has an opposite slope (opposite in sign) from the second angle 45. It may be advantageous for the fourth angle 65 to have a slope that is equal (in magnitude) or substantially equal (for example, within 5° to 10°) to the slope of the second angle 45. Advantageously, the vertical or substantially vertical walls adjacent the teeth 42, 62 and recesses 46, 66 may aid in aligning the segments 12, 14 as the segments 12, 14 are drawn together as the adjustable fasteners 24, 34 are tightened. Further, the vertical or substantially vertical walls adjacent the teeth 42, 62 and recesses 46, 66 may aid in preventing rotation of the segments 12, 14 after the segments 12, 14 are drawn together.

As shown in FIG. 2, the coupling 10 may further comprise a first pair of shoulders 41 positioned adjacent the first tooth 42 and the first recess 46. Each first shoulder 41 has a first shoulder surface 47. The coupling 10 may comprise a second pair of shoulders 61 positioned adjacent the second tooth 62 and the second recess 66. Each second shoulder 61 has a second shoulder surface 67. The first shoulder surface 47 may be oriented substantially parallel (for example, within 5° to 10° of parallel) or parallel to the first plane 87. The second shoulder surface 67 may be oriented substantially parallel (for example, within 5° to 10° of parallel) or parallel to the first plane 87.

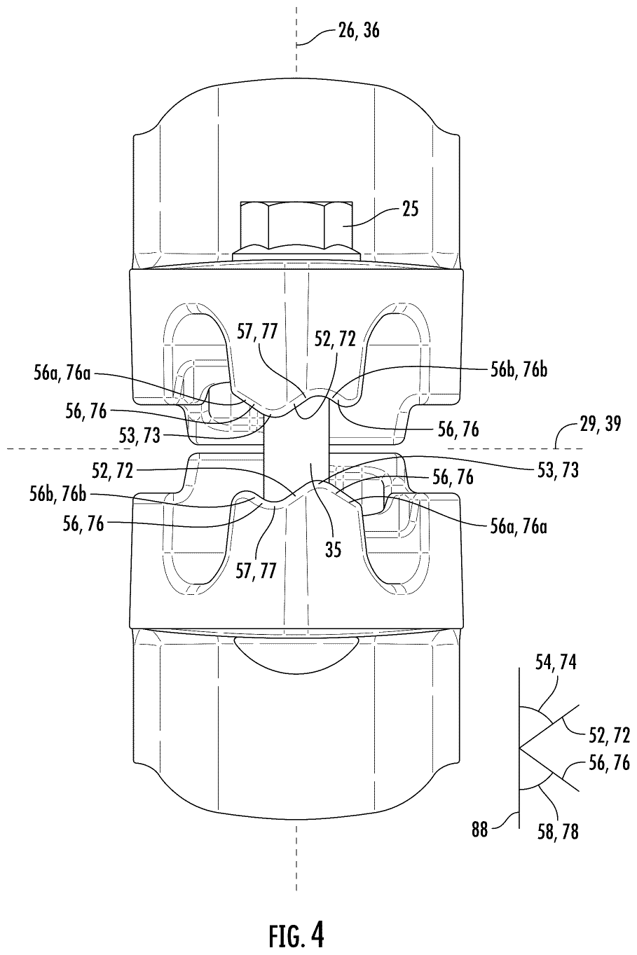

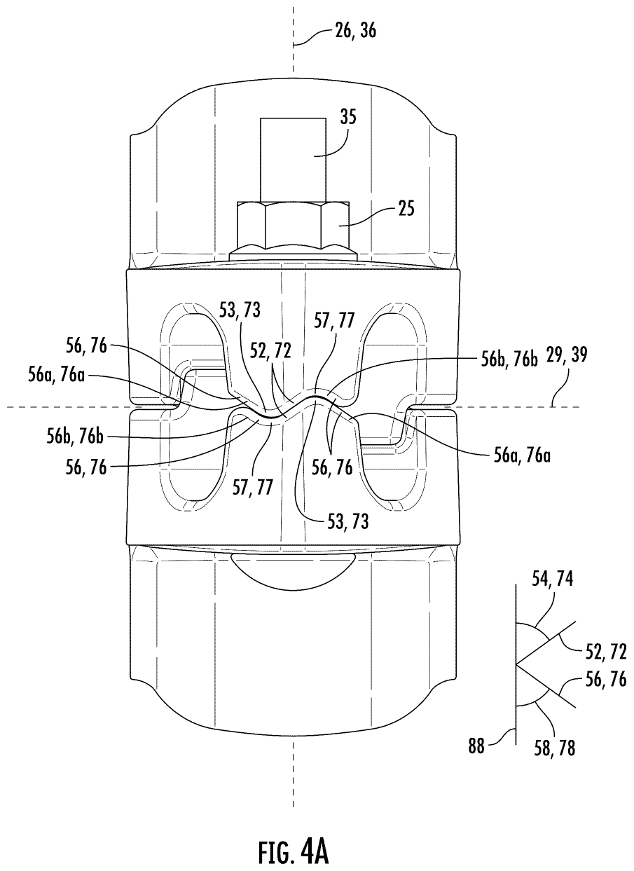

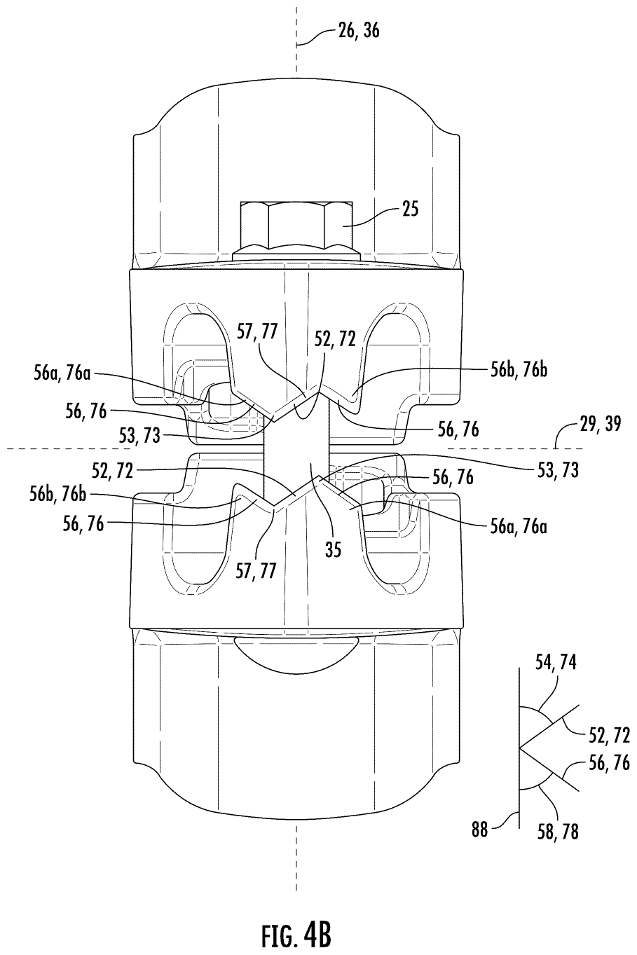

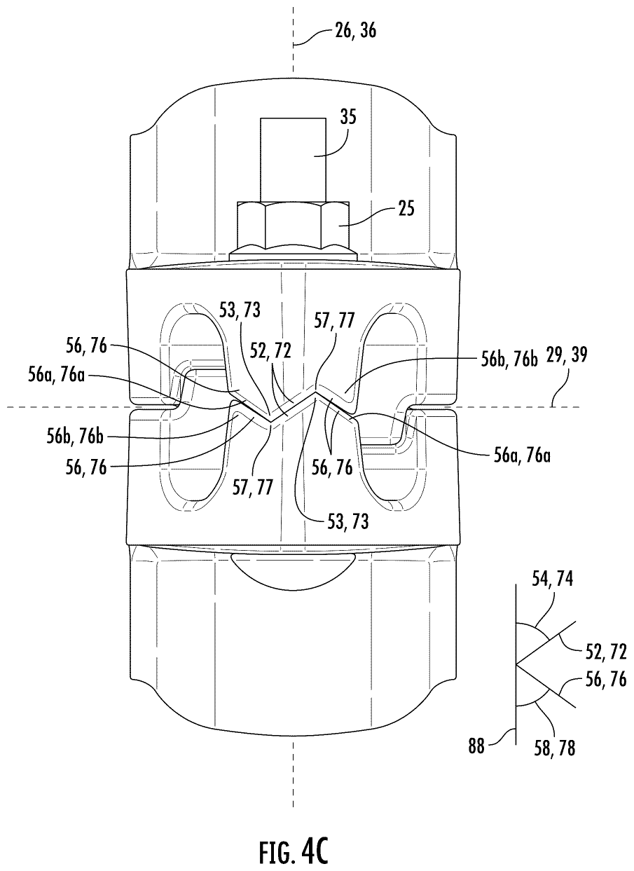

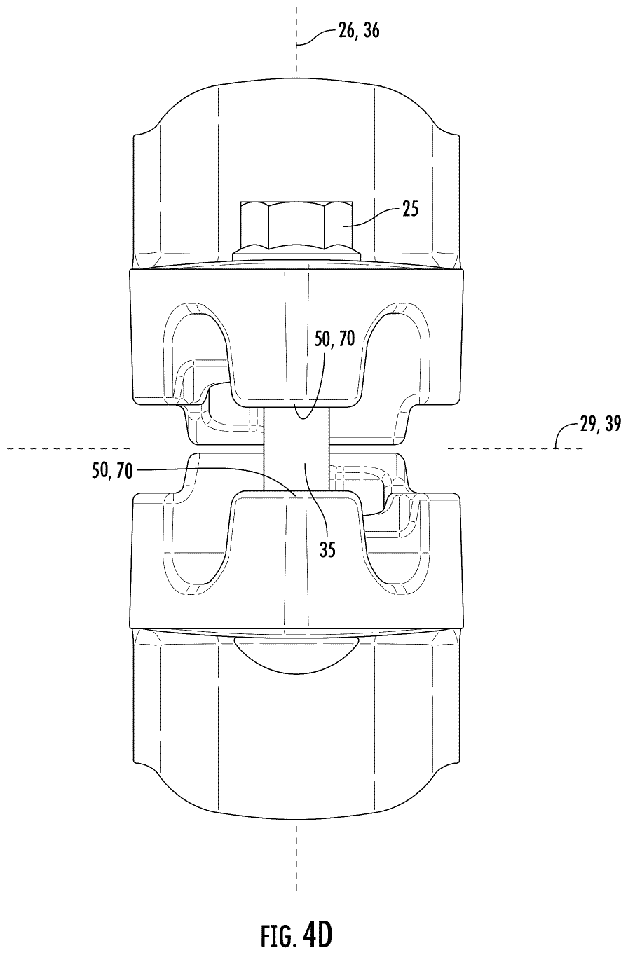

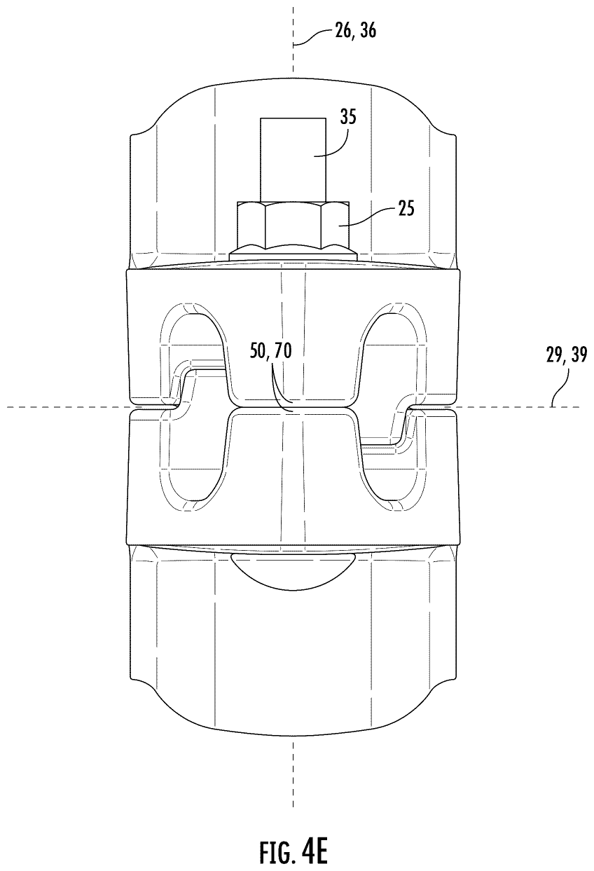

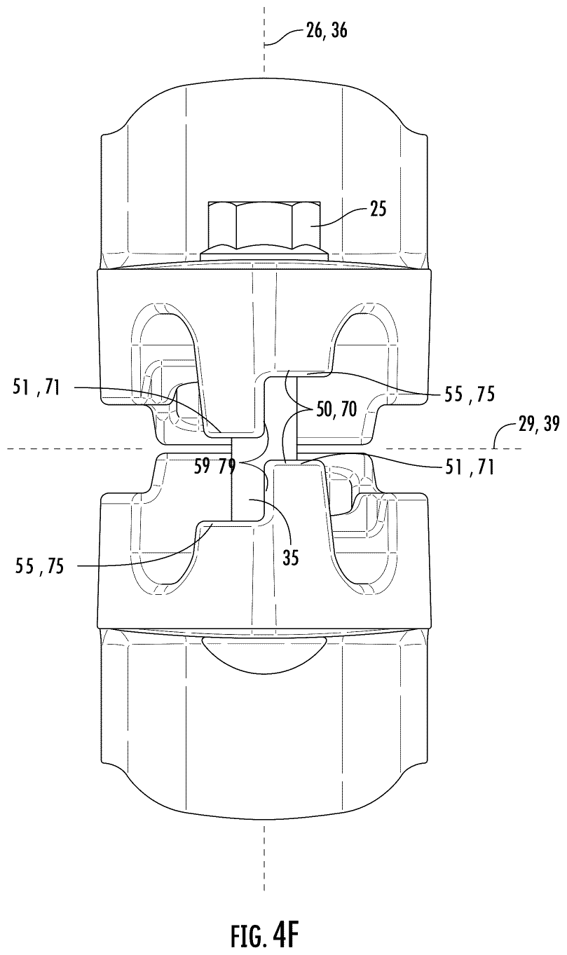

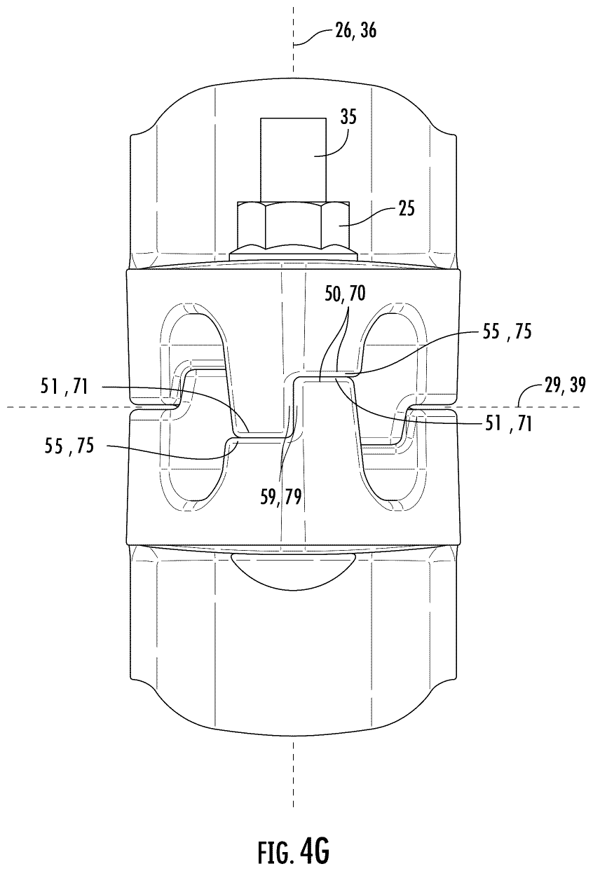

As shown in FIG. 1, each segment 12, 14 further comprises a first stop surface 50 positioned on the first lug 22. The first stop surface 50 may be in spaced apart relation from the first inner surface 40 with the first opening 28 and first adjustable fastener 24 positioned therebetween. As shown in FIGS. 4-4G, the geometry of the first stop surface 50 of the first segment 12 may be complementary to the geometry of the first stop surface 50 of the second segment 14. For example, when the first stop surface 50 of the first segment 12 defines a receiving space, the first stop surface 50 of the second segment 14 may be shaped to insert into the receiving space upon engagement between the first and second segments to interlock the first stop surfaces 50 as further described herein. Similarly, as another example, when the first stop surface 50 of the second segment 14 defines a receiving space, the first stop surface 50 of the first segment 12 may be shaped to insert into the receiving space upon engagement between the first and second segments to interlock the first stop surfaces 50 as further described herein. As shown in FIGS. 2 and 4-4C, the first stop surface 50 may comprise a first portion 52 oriented at a fifth angle 54 to a second plane 88. The second plane 88 contains the first and second longitudinal axes 26, 36 and the transverse axis 85. The first stop surface 50 may comprise at least one second portion 56 oriented at a seventh angle 58 to the second plane 88. The seventh angle 58 may have an opposite (in sign) slope from the fifth angle 54. The fifth angle 54 and seventh angle 58 may each be between 35° to 70° degrees. Optionally, the first stop surface 50 may comprise two second portions 56a, 56b. The first portion 52 may be positioned between the second portions 56a, 56b. As shown in FIGS. 4-4C, the first portion 52 and a second portion 56a may form a peak 53 and the first portion and the other second portion 56b may form a trough 57. The peak 53 of the first segment 12 may be complementary to the trough 57 of the second segment 15 and the peak 53 of the second segment 14 may be complementary to the trough 57 of the first segment 12. Optionally, as shown in FIGS. 4 and 4A, the first portion 52 and a second portion 56a may form a convex curve and the first portion and the other second portion 56b may form a concave curve. The convex curve of the first segment 12 may be complementary to the concave curve of the second segment 14 and the convex curve of the second segment 14 may be complementary to the concave curve of the first segment 12. Optionally, as shown in FIGS. 4F and 4G, the stop surface 50 includes a first portion 51 and a second portion 55 oriented parallel or substantially parallel (between 0 and 5°) to the first axis 29. A third portion 59 oriented parallel or substantially parallel (between 0 and 5°) to the longitudinal axis 26 is positioned between (optionally, extending between) the first and second portions 51, 55 such that the second portion 55 is recessed with respect to the first portion 51. The first portion 51 of the first segment 12 may be complementary to the second portion 55 of the second segment 14 and the first portion 51 of the second segment 14 may be complementary to the second portion 55 of the first segment 12. As shown, the first portion 51 of the stop surface 50 can be defined by a structure that projects away from the second portion 55. The second portion 55 and the third portion 59 of the stop surface 50 can at least partially define a receiving space that is configured to complementarily receive the structure that defines the first portion 51 of the stop surface.

As shown in FIG. 1, each segment 12, 14 further comprises a second stop surface 70 positioned on the second lug 32. The second stop surface 70 may be in spaced apart relation from the second inner surface 60 with the second opening 38 and second adjustable fastener 34 positioned therebetween. As shown in FIG. 4-4E, the geometry of the second stop surface 70 of the first segment 12 may be complementary to the geometry of the second stop surface 70 of the second segment 14. For example, when the second stop surface 70 of the first segment 12 defines a receiving space, the second stop surface 70 of the second segment 14 may be shaped to insert into the receiving space upon engagement between the first and second segments to interlock the second stop surfaces 70 as further described herein. Similarly, as another example, when the second stop surface 70 of the second segment 14 defines a receiving space, the second stop surface 70 of the first segment 12 may be shaped to insert into the receiving space upon engagement between the first and second segments to interlock the second stop surfaces 70 as further described herein. As shown in FIGS. 2 and 4-4C, the second stop surface 70 may comprise a first portion 72 oriented at a sixth angle 74 to the second plane 88. The sixth angle 74 may have an equal (in magnitude) or substantially equal (for example, within 5° to 10°) and opposite (in sign) slope from the fifth angle 54. The second stop surface 70 may comprise at least one second portion 76 oriented at an eighth angle 78 to the second plane 88. The eighth angle 78 may have an equal (in magnitude) or substantially equal (for example, within 5° to 10°) and opposite (in sign) slope from the seventh angle 58. The eighth angle 78 may have an opposite slope from the sixth angle 74. The sixth angle 74 and eighth angle 78 may each be between 35° to 70° degrees. Optionally, the second stop surface 70 may comprise two second portions 76a, 76b. As shown in FIGS. 4-4C, the first portion 72 may be positioned between the second portions 76a, 76b. The first portion 72 and a second portion 76a may form a peak 73 and the first portion and the other second portion 76b may form a trough 77. The peak 73 of the first segment 12 may be complementary to the trough 77 of the second segment 15 and the peak 73 of the second segment 14 may be complementary to the trough 77 of the first segment 12. Optionally, as shown in FIGS. 4 and 4A, the first portion 72 and a second portion 76a may form a convex curve and the first portion 72 and the other second portion 76b may form a concave curve. The convex curve of the first segment 12 may be complementary to the concave curve of the second segment 14 and the convex curve of the second segment 14 may be complementary to the concave curve of the first segment 12. Optionally, as shown in FIGS. 4F and 4G, the stop surface 70 includes a first portion 71 and a second portion 75 oriented parallel or substantially parallel (between 0 and 5°) to the second axis 39. A third portion 79 oriented parallel or substantially parallel (between 0 and 5°) to the longitudinal axis 26 is positioned between (optionally, extending between) the first and second portions 71, 75 such that the second portion 75 is recessed with respect to the first portion 71. The first portion 71 of the first segment 12 may be complementary to the second portion 75 of the second segment 14 and the first portion 71 of the second segment 14 may be complementary to the second portion 75 of the first segment 12. As shown, the first portion 71 of the stop surface 70 can be defined by a structure that projects away from the second portion 75. The second portion 75 and the third portion 79 of the stop surface 70 can at least partially define a receiving space that is configured to complementarily receive the structure that defines the first portion 71 of the stop surface.

Operation of the coupling 10 is described with reference to the Figures. FIGS. 5 and 6 show the example coupling 10 in the factory assembled configuration with segments 12 and 14 supported in spaced apart relation on seal 18 at a distance from one another sufficient to permit pipe elements (not shown) to be inserted into the central space 16. In this factory assembled example, fasteners 24 and 34 have been tightened sufficiently to hold the segments against the seal 18. The pipe elements are inserted into the central space 16 and their circumferential grooves are aligned with the arcuate projections 17, 19 on the segments 12 and 14. Fasteners 24 and 34 are then further tightened to draw segments 12 and 14 toward one another. As the fasteners 24, 34 are being adjusted to draw the segments 12, 14 toward one another, the arcuate projections 17, 19 engage with the circumferential grooves of the pipe elements. As the fasteners 24 and 34 are tightened, the segments 12 and 14 are aligned with respect to axes 26 and 36 as the segments 12 and 14 are drawn towards one another. The teeth 42, 62 and recesses 46, 66 may further ensure the segments 12 and 14 are aligned as the segments 12 and 14 are drawn together. With respect to FIGS. 4 and 4a, as the segments 12, 14 draw towards one another from a separated position (shown in FIG. 4) to a tightened condition (shown in FIG. 4a), the stop surfaces 50, 70 and their respective portions, 52, 56, 72, 76 move axially along the longitudinal axes 26, 36 of the fasteners. As the segments 12, 14 draw towards one another from a separated position (shown in FIG. 4) to a tightened condition (shown in FIG. 4a), the segments 12, 14 may not rotate or may only slightly rotate (for example, up to 5°) about axis 11 with respect to one another thereby minimizing or eliminating shifting between stop surfaces 50, 70 and their respective portions, 52, 56, 72, 76. Axis 11 is parallel to and centered between the longitudinal axes 26, 36. As shown in FIGS. 4 and 4E, complementary portions of the first stop surfaces 50 may remain in alignment (with respect to relative positions about axis 11) and complementary portions of the second stop surfaces 70 may remain in alignment (with respect to relative positions about axis 11) as the first and second segments draw towards one another to a tightened condition. For example, respective peaks and troughs 53, 57 of the first stop surfaces 50 may remain in alignment and the respective peaks and troughs 73, 77 of the second stop surfaces 70 may remain in alignment as the first and second segments 12, 14 draw towards one another to a tightened condition. The geometry of the first stop surfaces 50 including first and second portions 52, 56 may be such that the first and second segments 12, 14 do not rotate or only slightly rotate about axis 11 with respect to one another due to engagement between the first stop surfaces 50 of the first and second segments 12, 14. The geometry of the second stop surfaces 70 including first and second portions 72, 76 may be such that the first and second segments 12, 14 do not rotate or only slightly rotate about axis 11 with respect to one another due to engagement between the second stop surfaces 70 of the first and second segments 12, 14. Minimizing shifting between the first segment 12 and second segment 14 about axis 11 may reduce or eliminate any deformation of the seal 18 that may otherwise be caused by segments designed to rotate with respect to one another. Although FIGS. 4 and 4E show the coupling 10 without a seal 18, it is understood that the position and configuration of the segments 12, 14 in a factory assembled configuration and a tightened condition including a seal 18 correspond to the position and configuration of the segments 12, 14 shown in FIGS. 4 and 4E.

The contact between the coupling 10 and the pipe elements which the coupling may join creates a joint that is more stiff or rigid. Because the coupling 10 relies on contact between the coupling and the pipe elements, it may be affected by the wide tolerance range of the pipe surface as well as the tolerance range on the interfacing surface of the coupling. The tolerance ranges for the groove depth, groove width, and groove location in the pipe element are known to those of ordinary skill in the art and are codified by standards for grooves to promote interoperation of products and may include AWWA Standard for Grooved and Shouldered Joints C-606, which is hereby incorporated by reference in its entirety. The tolerance ranges for the diameter of the arcuate surfaces of the coupling segments (corresponding to the diameter of the best fit curve of the arcuate surfaces) as measured from the center of the respective segment are known to those of ordinary skill in the art (a range known in the art being about +/−0.040). A person of ordinary skill in the art would understand the arcuate surfaces of the segments may be imperfect.

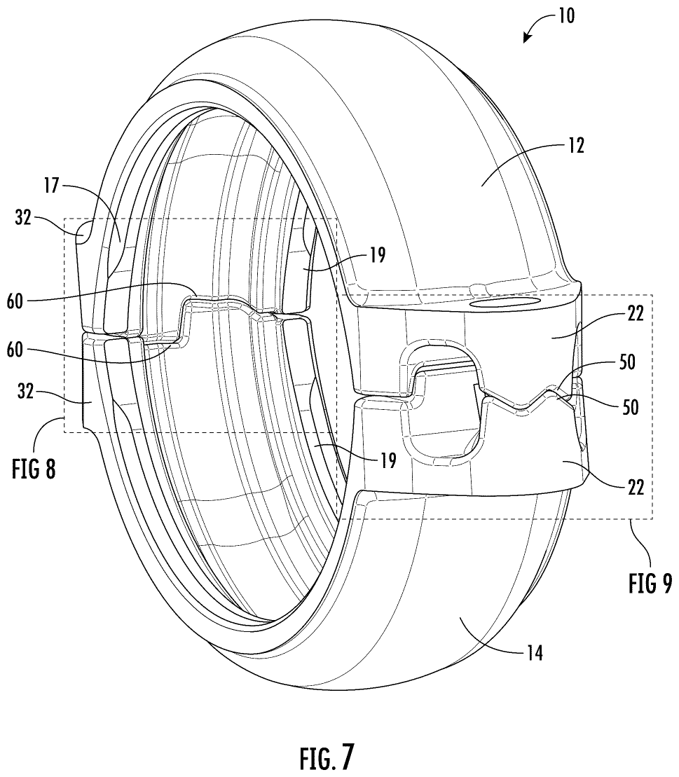

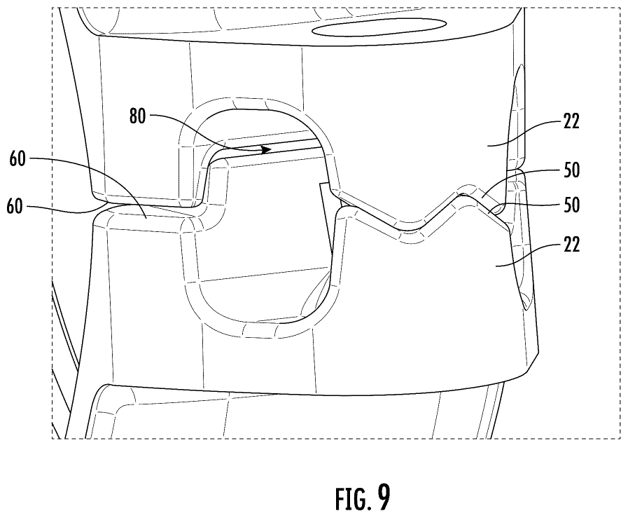

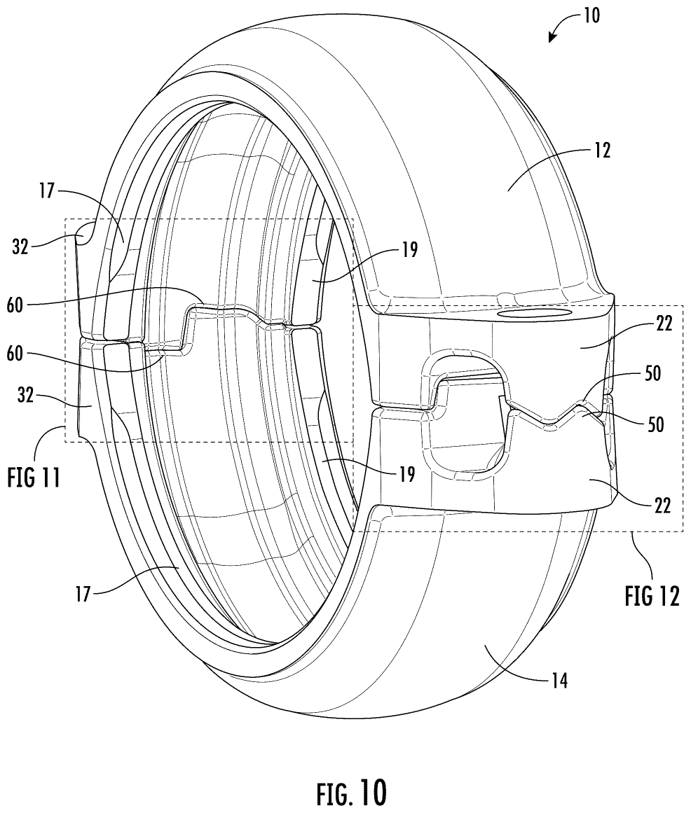

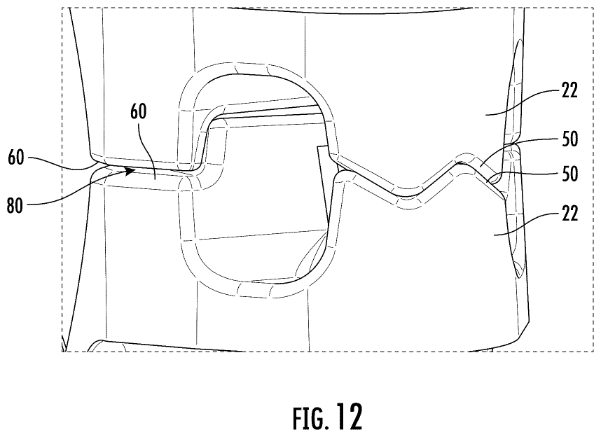

Coupling 10 is designed to produce a relatively rigid joint due to forceful contact between the arcuate surfaces of the segments and the floor of the groove between the pipe elements over a broad tolerance range of groove diameters (such as, for example, the range of groove diameters falling within the tolerances established by AWWA Standard for Grooved and Shouldered Joints C-606) and a broad tolerance range of diameters of the arcuate surfaces (corresponding to the diameters of the best fit curves of the arcuate surfaces) of the segments as measured from the center of the respective segment while still permitting visual indication that a proper joint has been formed. FIGS. 7 and 10 show the segments 12, 14 in an assembled or tightened condition after the adjustable fasteners 24, 34 have been tightened at different points within the tolerance ranges of the circumferential grooves in the pipe elements and the arcuate surfaces of the coupling segments (i.e. between a first extreme where the pipe diameter is largest and the arcuate surface diameter is smallest and a second extreme where the pipe diameter is smallest and the arcuate surface diameter is largest). The configurations described in FIGS. 7 and 10 are illustrative of certain tolerance conditions, and the full range of tolerance conditions encountered in field applications is contemplated within the scope of the disclosed couplings and joints, including tolerance conditions in between those specifically illustrated or recited herein. As the first adjustable fastener 24 and the second adjustable fastener 34 are adjusted to draw the first and second segments 12, 14 toward one another to the tightened condition, the first stop surfaces 50 of the segments 12, 14 engage and the second stop surfaces 70 of the segments 12, 14 engage. At a certain point, engagement between the arcuate projections 17, 19 and the circumferential grooves of the pipe element may prevent the segments 12, 14 from drawing towards one another. At this point, the first lugs 22 and second lugs 32 may bend toward one another respectively until the respective stop surfaces 50, 70 engage (see FIGS. 9 and 12). The stop surfaces 50, 70, including the geometry of the stop surfaces 50, 70, their lengths, positions on the segments and orientation angles, may mitigate rotation of the segments 12, 14 relative to one another caused by friction between torqued fasteners and their respective lugs upon engagement and prevent the segments 12, 14 from rotating relative to one another once the segments 12, 14 are drawn together. Engagement between the stop surfaces 50 and/or engagement between the stop surfaces 70 may also serve as final visual confirmation that the coupling 10 has been properly installed. The stop surfaces 50, 70 may provide this visual confirmation over the entire tolerance range (from the lower end point of the tolerance range to the higher end point of the tolerance range) imposed on the circumferential grooves in the pipe elements. Thus, regardless of where the circumferential grooves in the pipe elements fall on the tolerance spectrum the technician needs merely to tighten the fasteners 24 and 34 until the stop surfaces 50 and 70 engage. This engagement provides a final visual confirmation that the coupling 10 has been properly installed.

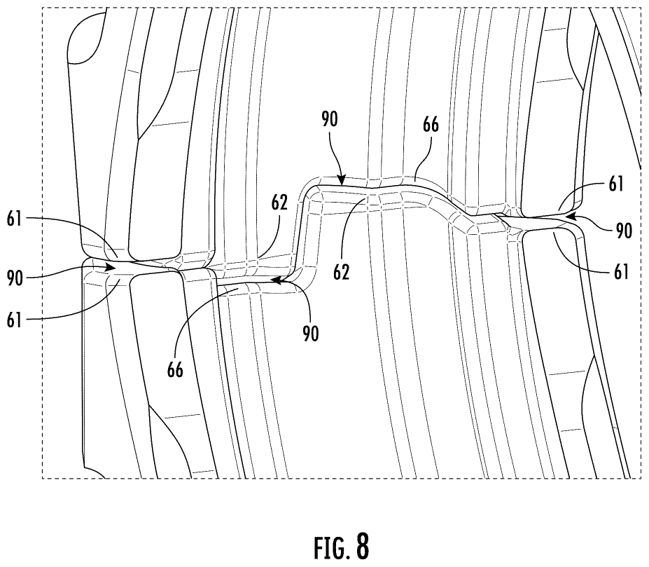

As shown in FIGS. 7-9, in a tightened condition under a first tolerance that is not at the higher end point of the groove diameter tolerance range, after the first stop surfaces 50 engage, there may be a first gap 80 between the first inner surfaces 40 (see FIG. 9). After the second stop surfaces 70 engage, there may be a second gap 90 between the second inner surfaces 60 (see FIG. 8). The first and second gaps 80, 90 may extend across the entire first and second inner surfaces 40, 60 (moving along axes 29, 39), including the respectively aligned teeth 42, 62 and recesses 46, 66, and the adjacent shoulders 41, 61. The positions of the shoulders 41, 61 relative to the teeth 42, 62 and recesses 46, 66 may leave larger gaps between shoulders 41, 61 than at the respectively aligned teeth 42, 62 and recesses 46, 66.

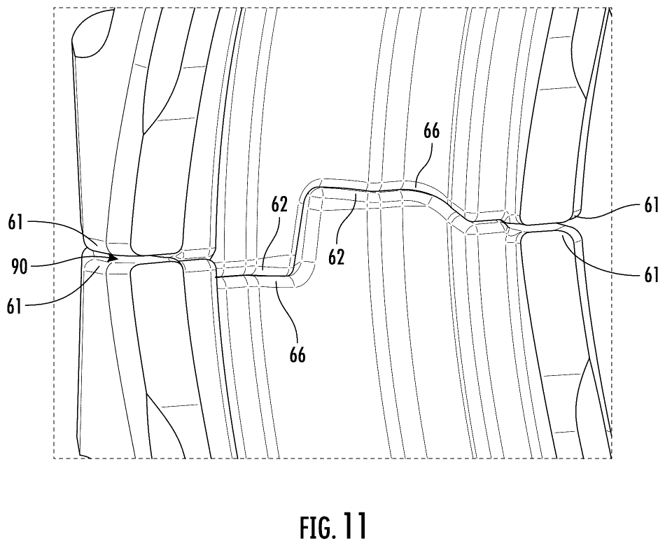

As shown in FIGS. 10-12, in a tightened condition under a second tolerance that may be at or near the higher end point of the groove diameter tolerance range, when the stop surfaces 50, 70 engage, at least a portion of the first and/or second inner surfaces 40, 60 may contact each other. As shown in FIGS. 11 and 12, the surfaces of the respectively aligned teeth 42, 62 and recesses 46, 66 may contact each other. A gap 81, 91 may remain between respective shoulders 41, 61. The gaps 81, 91 between respective shoulders 41, 61 may ensure sufficient contact between the arcuate projections 17, 19 of the segments 12, 14 and the floor of the circumferential grooves of the pipe elements.

In the tightened condition under the entire tolerance range, the respectively aligned teeth 42, 62 and recesses 44, 66 may provide structural support to the seal 18. The respectively aligned teeth 42, 62 and recesses 46, 66, including the geometry of the teeth surfaces 44, 64 and recess surfaces 48, 68, their dimensions, positions on the segments and orientation angles, may hide and/or protect the seal 18 and prevent the seal 18 from bulging into and extruding through the gap 80, 90 should the gap 80, 90 form thereby preventing a leak path from forming. By hiding the seal 18, the respectively aligned teeth 42, 62 and recesses 46, 66 prevent an installer from erroneously concluding the coupling 10 is improperly installed because the seal is visible. Further, the respectively aligned shoulders 41, 61 hide and/or protect the seal 18 and prevent the seal 18 from bulging into and extruding through the gap 80, 81, 90, 91 thereby preventing a leak path from forming. The gaps 80, 81, 90, 91 may also ensure alignment and contact between the stop surfaces 50 and between the stop surfaces 70 thereby effecting a rigid coupling.

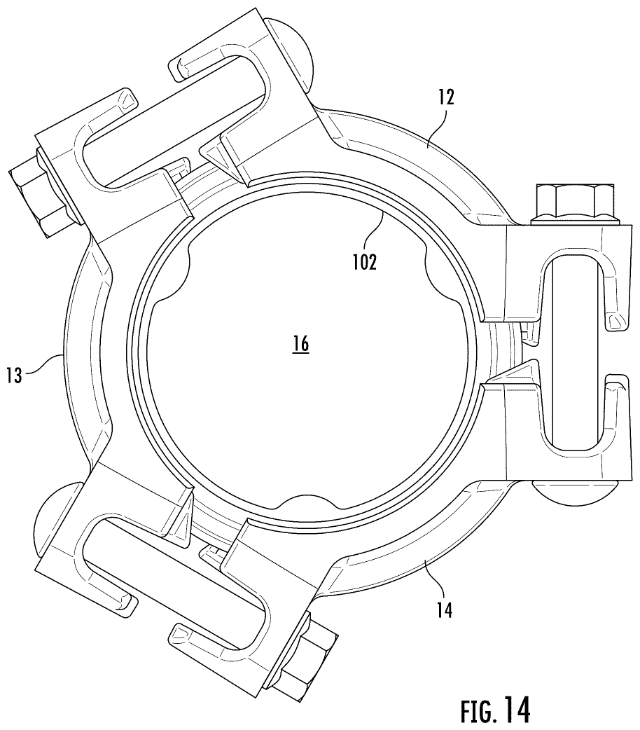

FIG. 14 illustrates another example embodiment of a coupling 110 according to the invention. Coupling 110 shares many of the features of coupling embodiment 10 as described above but comprises three segments 12, 13, 14 attached to one another end to end to surround and define the central space 16 for receiving the pipe element. The third segment 13 comprises the same or substantially the same features as the first and second segments 12, 14. Although coupling 110 has three segments 12, 13, 14, more than three segments is also practical. For example, the coupling may comprise four segments attached to one another end to end to surround and define the central space.

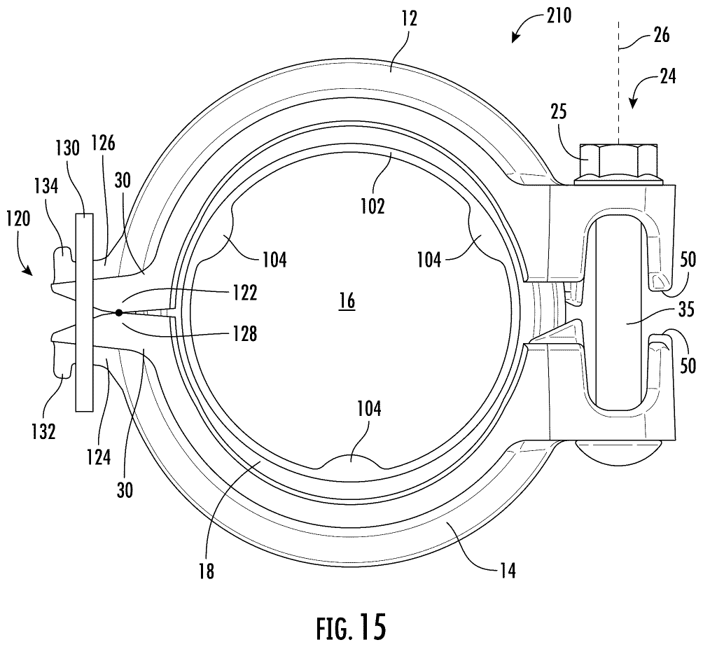

FIG. 15 illustrates another example embodiment of a coupling 210 according to the invention. Coupling 210 shares many of the features of coupling embodiment 10 as described above but substitutes a hinge in place of the second lugs 32. The second ends 30 of each segment 12 and 14, arranged opposite to the first ends 20, are connected to a hinge 120 joining the first and second segments to one another. The hinge 120 defines a hinge axis 122 oriented transversely to the longitudinal axis 26 of the first fastener 24. The first and second segments 12 and 14 are pivotable about the hinge axis 122. Adjusting the first fastener 24 pivots and thereby draws the first and second segments 12 and 14 toward one another, and engagement between the first stop surfaces 50 on the first lugs 26, as shown in FIG. 9 or 12 depending on tolerance ranges, arrests rotation of the segments relatively to one another. In this example embodiment, hinge 120 cantilevers 124, 126 engaging one another at a fulcrum 128. Cantilevers 124, 126 are joined by a ring 130, retained by projecting heads 132, 134 on each cantilever. Other forms of hinged joints, such as saddle and stirrup hinges, pinned hinges, cast hinges, and the like, are also practical.

The invention also encompasses a method of installing a coupling 10 as described herein for joining pipe elements in end to end relation. In an example embodiment, the method comprises:
with the coupling in the factory assembled configuration, adjusting the first adjustable fastener 24 to draw the first and second segments 12, 14 toward one another;
engaging the first stop surfaces 50 at the first end 20 of the segments 12, 14;
adjusting the second adjustable fastener 34 to draw the first and second segments 12, 14 toward one another; and
engaging the second stop surfaces 70 of the second end 30 of the segments 12, 14.

Optionally, the first stop surfaces 50 at the first end 20 of the segments 12, 14 engage before adjusting the second adjustable fastener 34.

The coupling 10 is in the tightened condition after the second stop surfaces engage.

Optionally, the first segment 12 and said second segment 14 are in an alignment (with respect to positions about axis 11) and remain in the alignment in the tightened condition.

It is expected that couplings according to the invention will easily assemble to join pipe elements together while providing consistent and unambiguous visual indication of proper installation and protecting and properly compressing the seal.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A coupling for joining pipe elements in end to end relation, the coupling comprising:
first and second segments attached to one another end to end surrounding a central space for receiving the pipe elements, each the segment comprising a first lug extending from a first end thereof and a second lug extending from a second end thereof;
a first adjustable fastener extending between the first lugs along a first longitudinal axis and a second adjustable fastener extending between the second lugs along a second longitudinal axis; wherein
each the segment further comprises:
   a first inner surface positioned between the central space and the first lug, the first inner surface comprising a first tooth and a first recess;
   a first stop surface positioned on the first lug, the first adjustable fastener being positioned between the first inner surface and the first stop surface;
   a second inner surface positioned between the central space and the second lug, the second inner surface comprising a second tooth and a second recess; and
   a second stop surface positioned on the second lug, the second adjustable fastener being positioned between the second inner surface and the second stop surface; wherein
the first and second segments are movable toward one another to a tightened condition;
the first and second adjustable fasteners are configured to draw the first and second segments toward one another to the tightened condition; and wherein
in the tightened condition:
the first stop surfaces at the first ends of the segments engage and the second stop surfaces at the second ends of the segments engage; and
the first tooth of the first segment is at least partially received within the first recess of the second segment and the first tooth of the second segment is at least partially received within the first recess of the first segment.

Aspect 2: The coupling according to aspect 1, wherein in the tightened condition, the second tooth of the first segment mates with the second recess of the second segment and the second recess of the first segment mates with the second tooth of the second segment.

Aspect 3: The coupling according to any of the preceding aspects, wherein in the tightened condition, a first gap is present between the first stop surfaces.

Aspect 4: The coupling according to aspect 3, wherein in the tightened condition, a second gap is present between the second inner surfaces.

Aspect 5: The coupling according to any of the preceding aspects, wherein the first lugs define a first opening surrounding a first axis oriented perpendicularly to the first longitudinal axis of the first adjustable fastener and positioned between the first inner surfaces and the first stop surfaces.

Aspect 6: The coupling according to aspect 5, wherein the first opening extends through the first lugs.

Aspect 7: The coupling according to aspect 5, wherein the second lugs define a second opening surrounding a second axis oriented perpendicularly to the second longitudinal axis of the second adjustable fastener and positioned between the second inner surfaces and the second stop surfaces.

Aspect 8: The coupling according to aspect 7, wherein the second opening extends through the second lugs.

Aspect 9: The coupling according to any of the preceding aspects, wherein:
the first tooth of the first segment aligns with the first recess of the second segment, and
the first recess of the first segment aligns with the first tooth of the second segment.

Aspect 10: The coupling according to any of the preceding aspects, wherein the first tooth surface is oriented at a first angle to a first plane, the first plane containing a transverse axis and the first and second axes, the transverse axis oriented perpendicularly to the first and second longitudinal axes and the first and second axes, and wherein the first recess surface is oriented at a second angle to the first plane.

Aspect 11: The coupling according to aspect 10, wherein the second angle has an opposite slope from the first angle.

Aspect 12: The coupling according to aspect 11, wherein a magnitude of the second angle is substantially the same as a magnitude of the first angle.

Aspect 13: The coupling according to aspect 11, wherein the slope of the first angle ranges from 10° to 70°, and the slope of the second angle ranges from 10° to 70°.

Aspect 14: The coupling according to any of the preceding aspects, wherein:
the second tooth of the first segment aligns with the second recess of the second segment, and
the second recess of the first segment aligns with the second tooth of the second segment.

Aspect 15: The coupling according to any of the preceding aspects, wherein the second tooth surface is oriented at a third angle to the first plane, and the second recess surface is oriented at a fourth angle to the first plane.

Aspect 16: The coupling according to aspect 15, wherein the third angle has an equal and opposite slope from the first angle, and the fourth angle has an equal and opposite slope from the second angle.

Aspect 17: The coupling according to aspect 13, further comprising:
a first pair of shoulders positioned adjacent the first tooth and the first recess, each shoulder of the first pair of shoulders having a first shoulder surface; and
a second pair of shoulders positioned adjacent the second tooth and the second recess, each shoulder of the second pair of shoulders having a second shoulder surface.

Aspect 18: The coupling according to aspect 17, wherein the first shoulder surface is oriented substantially parallel to the first plane, and the second shoulder surface is oriented substantially parallel to the first plane.

Aspect 19: The coupling according to any of the preceding aspects, wherein the first stop surface comprises a first portion oriented at a fifth angle to a second plane, the second plane containing the first and second longitudinal axes and the transverse axis, wherein the second stop surface comprises a first portion oriented at a sixth angle to the second plane.

Aspect 20: The coupling according to aspect 19, wherein the sixth angle has an equal and opposite slope from the fifth angle.

Aspect 21: The coupling according to aspect 20, wherein the first stop surface further comprises at least one second portion oriented at a seventh angle to the second plane, and the second stop surface comprises at least one second portion oriented at an eighth angle to the second plane.

Aspect 22: The coupling according to aspect 21, wherein the eighth angle has an equal and opposite slope from the seventh angle.

Aspect 23: The coupling according to aspect 21, wherein the seventh angle has an opposite slope from the fifth angle, and the eighth angle has an opposite slope from the sixth angle.

Aspect 24: The coupling according to any of the preceding aspects, wherein each one of the first and second adjustable fasteners comprises a nut and bolt.

Aspect 25: The coupling according to any of the preceding aspects, wherein each of the segments comprises first and second arcuate projections positioned on opposite sides of the segments, each of the first and second arcuate projections facing the central space, each of the first and second arcuate projections being engageable within circumferential grooves in the pipe elements when the segments are drawn toward one another by the first and second adjustable fasteners.

Aspect 26: The coupling according to any of the preceding aspects, further comprising a seal positioned within the central space, the seal supporting the segments in spaced apart relation sufficient to permit insertion of the pipe elements into the central space without disassembling the coupling.

Aspect 27: A method of using the coupling according to any of the preceding aspects, the method comprising:
adjusting the first adjustable fastener to draw the first and second segments toward one another;
engaging the first stop surfaces at the first end of the segments;
adjusting the second adjustable fastener to draw the first and second segments toward one another; and
engaging the second stop surfaces of the second end of the segments.

Aspect 28: The method according to aspect 27, wherein the first stop surfaces at the first end of the segments engage before adjusting the second adjustable fastener.

Aspect 29: The method according to aspect 28, wherein the coupling is in the tightened condition after the second stop surfaces engage.

Aspect 30: The method according to aspect 29, wherein the first segment and the second segment are in an alignment with respect to an axis parallel to and centered between the first longitudinal axis and the second longitudinal axis and remain in the alignment in the tightened condition.

Aspect 31: A coupling for joining pipe elements in end to end relation, the coupling comprising:
first and second segments attached to one another end to end surrounding a central space for receiving the pipe elements, each the segment comprising a first end and a second end, each the segment comprising a first lug extending from a first end thereof;
a first adjustable fastener extending between the first lugs along a first longitudinal axis; and
a hinge assembly attaching the second ends of the first and second segments; wherein
each the segment further comprises:
   a first inner surface positioned between the central space and the first lug, the first inner surface comprising a first tooth and a first recess; and
   a first stop surface positioned on the first lug, the first adjustable fastener being positioned between the first inner surface and the first stop surface; wherein
the first and second segments are movable toward one another to a tightened condition;

the first adjustable fastener is configured to draw the first and second segments toward one another to the tightened condition; and wherein
in the tightened condition:
the first stop surfaces at the first ends of the segments engage, and
the first tooth of the first segment is at least partially received within the first recess of the second segment and the first tooth of the second segment is at least partially received within the first recess of the first segment.

Aspect 32: The coupling according to aspect 31, wherein in the tightened condition, a first gap is present between the first stop surfaces.

Aspect 33: The coupling according to any of aspects 31-32, wherein the first lugs define a first opening surrounding a first axis oriented perpendicularly to the first longitudinal axis of the first adjustable fastener and positioned between the first inner surfaces and the first stop surfaces.

Aspect 34: The coupling according to aspect 33, wherein the first opening extends through the first lugs.

Aspect 35: The coupling according to any of aspects 31-34, wherein:
the first tooth of the first segment aligns with the first recess of the second segment, and
the first recess of the first segment aligns with the first tooth of the second segment.

Aspect 36: The coupling according to any of aspects 31-35, wherein the first tooth surface is oriented at a first angle to a first plane, the first plane containing a transverse axis and the first and second axes, the transverse axis oriented perpendicularly to the first and second longitudinal axes and the first and second axes, and wherein the first recess surface is oriented at a second angle to the first plane.

Aspect 37: The coupling according to aspect 36, wherein the second angle has an opposite slope from the first angle.

Aspect 38: The coupling according to aspect 37, wherein a magnitude of the second angle is substantially the same as a magnitude of the first angle.

Aspect 39: The coupling according to aspect 37, wherein the slope of the first angle ranges from 10° to 70°, and the slope of the second angle ranges from 10° to 70°.

Aspect 40: The coupling according to any of aspects 31-39, further comprising:
a first pair of shoulders positioned adjacent the first tooth and the first recess, each shoulder of the first pair of shoulders having a first shoulder surface.

Aspect 41: The coupling according to aspect 40, wherein the first shoulder surface is oriented substantially parallel to the first plane.

Aspect 42: The coupling according to any of aspects 31-41, wherein the first stop surface comprises a first portion oriented at a fifth angle to a second plane, the second plane containing the first and second longitudinal axes and the transverse axis.

Aspect 43: The coupling according to aspect 42, wherein the first stop surface further comprises at least one second portion oriented at a seventh angle to the second plane.

Aspect 44: The coupling according to aspect 42, wherein the seventh angle has an opposite slope from the fifth angle.

Aspect 45: The coupling according to any of aspects 31-44, wherein the first adjustable fastener comprises a nut and bolt.

Aspect 46: The coupling according to any of aspects 31-45, wherein each of the segments comprises first and second arcuate projections positioned on opposite sides of the segments, each of the first and second arcuate projections facing the central space, each of the first and second arcuate projections being engageable within circumferential grooves in the pipe elements when the segments are drawn toward one another by the first adjustable fasteners.

Aspect 47: The coupling according to any of aspects 31-46, further comprising a seal positioned within the central space, the seal supporting the segments in spaced apart relation sufficient to permit insertion of the pipe elements into the central space without disassembling the coupling.

What is claimed is:

1. A coupling for joining pipe elements in end to end relation, said coupling comprising:
first and second segments attached to one another end to end surrounding a central space for receiving said pipe elements, each said segment comprising a first lug extending from a first end thereof and a second lug extending from a second end thereof;
a first adjustable fastener extending between said first lugs along a first longitudinal axis and a second adjustable fastener extending between said second lugs along a second longitudinal axis; wherein
each said segment further comprises:
a first inner surface positioned between said central space and said first lug, said first inner surface comprising a first tooth and a first recess;
a first stop surface positioned on said first lug, said first adjustable fastener being positioned between said first inner surface and said first stop surface;
a second inner surface positioned between said central space and said second lug, said second inner surface comprising a second tooth and a second recess; and
a second stop surface positioned on said second lug, said second adjustable fastener being positioned between said second inner surface and said second stop surface; wherein
said first and second segments are movable toward one another to a tightened condition;
said first and second adjustable fasteners are configured to draw said first and second segments toward one another to said tightened condition; and wherein
in said tightened condition:
said first stop surfaces at said first ends of said segments engage and said second stop surfaces at said second ends of said segments engage; and
said first tooth of said first segment is at least partially received within said first recess of said second segment and said first tooth of said second segment is at least partially received within said first recess of said first segment.

2. The coupling according to claim 1, wherein in said tightened condition, said second tooth of said first segment mates with said second recess of said second segment and said second recess of said first segment mates with said second tooth of said second segment.

3. The coupling according to claim 1, wherein in said tightened condition, a first gap is present between said first stop surfaces.

4. The coupling according to claim 3, wherein in said tightened condition, a second gap is present between said second inner surfaces.

5. The coupling according to claim 1, wherein said first lugs define a first opening surrounding a first axis oriented perpendicularly to said first longitudinal axis of said first adjustable fastener and positioned between said first inner surfaces and said first stop surfaces.

6. The coupling according to claim 5, wherein said first opening extends through said first lugs.

7. The coupling according to claim 5, wherein said second lugs define a second opening surrounding a second axis oriented perpendicularly to said second longitudinal axis of said second adjustable fastener and positioned between said second inner surfaces and said second stop surfaces.

8. The coupling according to claim 7, wherein said second opening extends through said second lugs.

9. The coupling according to claim 1, wherein:
said first tooth of said first segment aligns with said first recess of said second segment, and
said first recess of said first segment aligns with said first tooth of said second segment.

10. The coupling according to claim 1, wherein said first tooth surface is oriented at a first angle to a first plane, said first plane containing a transverse axis and said first and second axes, said transverse axis oriented perpendicularly to said first and second longitudinal axes and said first and second axes, and wherein said first recess surface is oriented at a second angle to said first plane.

11. The coupling according to claim 10, wherein said second angle has an opposite slope from said first angle.

12. The coupling according to claim 11, wherein a magnitude of said second angle is substantially the same as a magnitude of said first angle.

13. The coupling according to claim 11, wherein said slope of said first angle ranges from 10° to 70°, and said slope of said second angle ranges from 10° to 70°.

14. The coupling according to claim 1, wherein:
said second tooth of said first segment aligns with said second recess of said second segment, and
said second recess of said first segment aligns with said second tooth of said second segment.

15. The coupling according to claim 1, wherein said second tooth surface is oriented at a third angle to said first plane, and said second recess surface is oriented at a fourth angle to said first plane.

16. The coupling according to claim 15, wherein said third angle has an equal and opposite slope from said first angle, and said fourth angle has an equal and opposite slope from said second angle.

17. The coupling according to claim 13, further comprising:
a first pair of shoulders positioned adjacent said first tooth and said first recess, each shoulder of said first pair of shoulders having a first shoulder surface; and
a second pair of shoulders positioned adjacent said second tooth and said second recess, each shoulder of said second pair of shoulders having a second shoulder surface.

18. The coupling according to claim 17, wherein said first shoulder surface is oriented substantially parallel to said first plane, and said second shoulder surface is oriented substantially parallel to said first plane.

19. The coupling according to claim 1, wherein said first stop surface comprises a first portion oriented at a fifth angle to a second plane, said second plane containing said first and second longitudinal axes and said transverse axis, wherein said second stop surface comprises a first portion oriented at a sixth angle to said second plane.

20. The coupling according to claim 19, wherein said sixth angle has an equal and opposite slope from said fifth angle.

21. The coupling according to claim 20, wherein said first stop surface further comprises at least one second portion oriented at a seventh angle to said second plane, and said second stop surface comprises at least one second portion oriented at an eighth angle to said second plane.

22. The coupling according to claim 21, wherein said eighth angle has an equal and opposite slope from said seventh angle.

23. The coupling according to claim 21, wherein said seventh angle has an opposite slope from said fifth angle, and said eighth angle has an opposite slope from said sixth angle.

24. The coupling according to claim 1, wherein each one of said first and second adjustable fasteners comprises a nut and bolt.

25. The coupling according to claim 1, wherein each of said segments comprises first and second arcuate projections positioned on opposite sides of said segments, each of said first and second arcuate projections facing said central space, each of said first and second arcuate projections being engageable within circumferential grooves in said pipe elements when said segments are drawn toward one another by said first and second adjustable fasteners.

26. The coupling according to claim 1, further comprising a seal positioned within said central space, said seal supporting said segments in spaced apart relation sufficient to permit insertion of said pipe elements into said central space without disassembling said coupling.

27. A method of using said coupling according to claim 1, said method comprising:
adjusting said first adjustable fastener to draw said first and second segments toward one another;
engaging said first stop surfaces at said first end of said segments;
adjusting said second adjustable fastener to draw said first and second segments toward one another; and
engaging said second stop surfaces of said second end of said segments.

28. The method according to claim 27, wherein said first stop surfaces at said first end of said segments engage before adjusting said second adjustable fastener.

29. The method according to claim 28, wherein said coupling is in said tightened condition after said second stop surfaces engage.

30. The method according to claim 29, wherein said first segment and said second segment are in an alignment with respect to an axis parallel to and centered between said first longitudinal axis and said second longitudinal axis and remain in said alignment in said tightened condition.
